(19) United States
(12) Patent Application Publication
(10) Pub. No.: US 2007/0143148 A1
(43) Pub. Date: Jun. 21, 2007

(54) Anonymous brokering of patient health records

(75) Inventors: Tomer Kol, Yoqneam Illit (IL); William C. Rapp, Rochester, MN (US); Richard J. Stevens, Rochester, MN (US); Karen A. Witting, Croton-on-Hudson, NY (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/304,137

(22) Filed: Dec. 15, 2005

(51) Int. Cl. G06F 19/00; G06Q 40/00

(52) U.S. Cl. 705/3; 705/4

(57) ABSTRACT

Method, apparatus and article of manufacture for brokering electronic health records of individuals. The individuals define respective policies that govern the accessibility to their records. Requests for health records are processed by applying the appropriate policies to determine which records may be returned.

### CROSS-REFERENCE TO RELATED APPLICATIONS

This application is related to the following commonly-owned, co-pending U.S. patent applications all of which are incorporated herein by reference: MANAGING ELECTRONIC HEALTH RECORDS WITHIN A WIDE AREA CARE PROVIDER DOMAIN, filed Sep. 30, 2005, application Ser. No. 11/241,707, (Attorney Docket ROC920050200US1); ELECTRONIC HEALTH RECORD TRANSACTION MONITORING, filed Sep. 30, 2005, application Ser. No. 11/241,706, (Attorney Docket ROC920050201US1); MULTIPLE ACCOUNTS FOR HEALTH RECORD BANK, filed Sep. 30, 2005, application Ser. No. 11/241,705, (Attorney Docket ROC920050202US1); CHECKBOOK TO CONTROL ACCESS TO HEALTH RECORD BANK ACCOUNT, filed Sep. 30, 2005, application Ser. No. 11/241,704, (Attorney Docket ROC920050203US1); and MODELS FOR SUSTAINING AND FACILITATING PARTICIPATION IN HEALTH RECORD DATA BANKS, filed Sep. 30, 2005, application Ser. No. 11/241,703, (Attorney Docket ROC920050204US1).

### BACKGROUND OF THE INVENTION

1. Field of the Invention

Embodiments of the present invention are generally related to generating fees on the basis of accesses to health records.

2. Description of the Related Art

Electronic data is pervasive. Electronic data records have been created to capture details about almost any conceivable transaction or event. Heath records, for example, contain various data about patients, including medical history data, test data, medication data, etc. Electronic health records (EHRs) have become a vital resource for doctors, researchers, laboratories, insurance providers, and claims-processors, etc.

While access to the available data has historically been hindered by the distribution of the data over multiple disparate entities, these entities are becoming increasingly more interconnected. For example, a national health information infrastructure can be created from many regional networks, wherein each regional network shares access to (or stores) electronic health records among a number of participants. Once established, these regional networks (referred to herein as RHIOs, for Regional Health Information Organization) may be connected to form a nation-wide infrastructure. Thus, a national health information network may emerge from a specialized “network of networks,” making electronic hearth records available to health care providers when and where they are needed.

With increased accessibility and volume of electronic health records, the value and interest of this data for research study and clinical trial activities proportionately increases. However, there exists a tension between EHR “consumers” (medical research and clinical trial organizations) and the individuals whose data is contained in the electronic health records. That is, while providing EHR consumers accessibility to the data, individual privacy must be protected and individual control over use of their data must be established.

Conventionally, organizations interested in health data will solicit participants by advertising, and in some cases offering a fee for participation in a given project. Prospective participants may be required to fill out a yes/no document stating whether their data can be used for research within the immediate organization making the request. However, such methods are associated with a high cost to acquire appropriate participants for the medial research and clinical trials, and offer no flexibility to the participants regarding the capacity and extent to which their data will be used.

Accordingly, there remains a need for an EHR system that provides a level of accessibility to data while providing user control/awareness in a manner that promotes the wide spread adoption of the system.

### SUMMARY OF THE INVENTION

The present invention generally relates to brokering health records.

One embodiment provides a computer-implemented method of brokering health-related data in which a network request for health-related data pertaining to individuals is received from a requesting entity. The health-related data satisfying the request are identified. One or more policies are applied to the identified health-related data; wherein the policies define access restrictions to the identified health-related data of the respective individuals to whom the identified health-related data pertains; and wherein the applied polices are defined by the respective individuals to whom the identified health-related data pertains. A portion of the health-related data is returned to the requesting entity as permitted by the applied policies and which satisfies the network request.

Another embodiment provides a computer-implemented method of brokering health-related data pertaining to individuals in which health-related data satisfying a first request received from a requesting entity is identified. Policies are applied to the identified health-related data; wherein the policies define access restrictions to the identified health-related data of the respective individuals to whom the identified health-related data pertains; wherein the applied polices are defined by the respective individuals to whom the identified health-related data pertains; and wherein at least one of the applied policies specifies that the identity of the respective individual is to remain anonymous, while health-related data of the respective individual may be disclosed. A portion of the health-related data is returned to the requesting entity as permitted by the applied policies and which satisfies the first network request. A second network request indicating an interest in contacting the anonymous individual is then received from the requesting entity and the anonymous individual is notified of the second network request while maintaining the anonymity of the anonymous individual relative to the requesting entity.

Another embodiment provides a heath data brokering system. The system includes a database containing health-related data pertaining to individuals; a plurality of polices defining access restrictions to the health-related data, wherein the polices are defined by the respective individuals to whom the identified health-related data pertains; and a broker. The broker is configured to receive, from requesting entities, network requests for the health-related data; identify health-related data satisfying the request and the access restrictions of the policies; and

return, via a network communication, a portion of the health-related data as permitted by the policies and which satisfies the respective network requests.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a health record brokering environment, according to one embodiment.

FIG. 2 is a usage policy for a given individual, according to one embodiment.

FIG. 3 is a flow chart illustrating the operation of a patient health record broker.

### DETAILED DESCRIPTION OF THE PREFERRED EMBODIMENTS

The present invention is directed to brokering electronic health records of individuals. The individuals define respective policies that govern the accessibility to their respective records.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

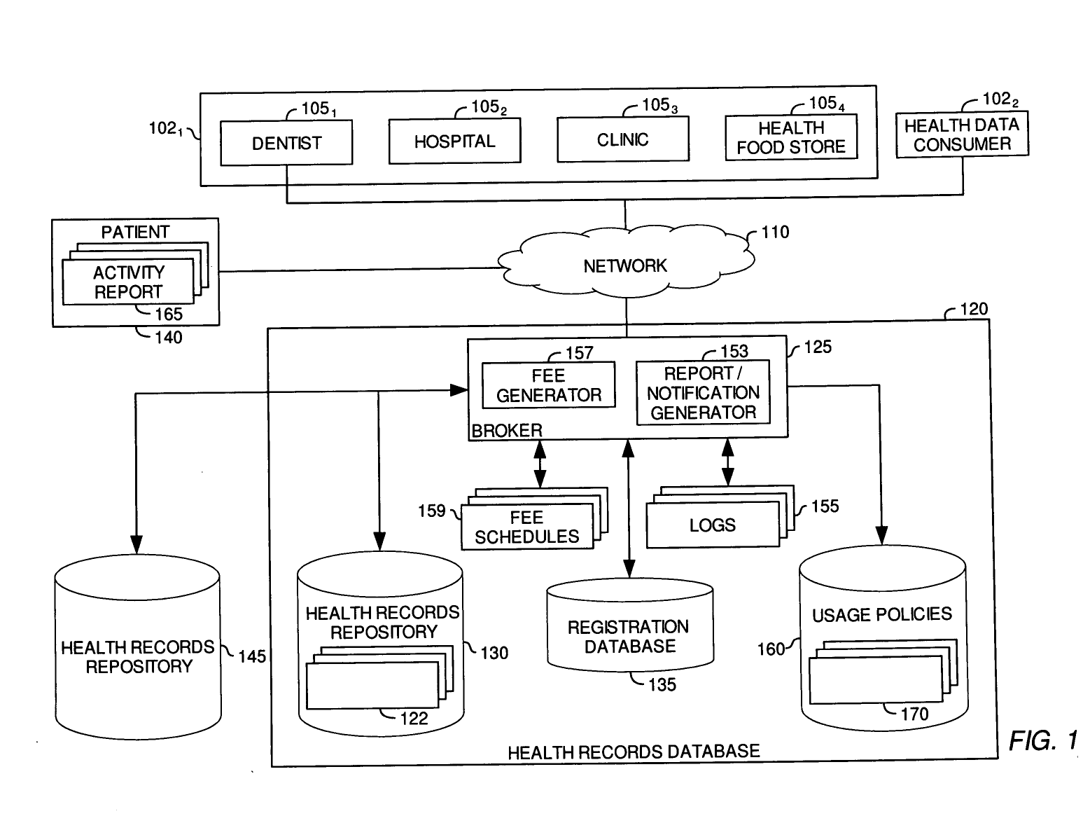

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Embodiments of the invention may be implemented, in part, using computer software applications executing on existing computer systems, e.g., desktop computers, server computers, laptop computers, tablet computers, and the like. The health records transaction environment described herein, however, is not limited to any currently existing computing or data communications environment, and may be adapted to take advantage of new computing systems as they become available.

FIG. 1 is a functional block diagram illustrating an exemplary computing and data communications environment 100, according to one embodiment of the invention. FIG. 1 shows a healthcare records databank (HRDB) 120 that stores and manages health related data derived from a plurality of patients 140. Reference is made herein to “patients” only for convenience; it is to be understood a “patient” means any individual for whom data is being managed, regardless whether the individual is currently undergoing treatment or testing for medical or research purposes. In addition to health related data, the patient data stored in the HRDB 120 may also include contact information (e.g., address, phone numbers, etc.) for the various individual patients. In one embodiment, the patient data is stored in the form of electronic health records (EHRs) 122 in a health records repository 130. In one embodiment, the data repository 130 may be a relational database configured to store data according to a schema of related tables and columns, queried using the known SQL query language. However, other storage formats may be used.

The electronic health records 122 may include any data related to the patient 140 that may be represented in a digital form and stored in data repositories 130. Illustrative examples include text documents, spread-sheets, database records, XML data, imaging data (e.g., x-rays CT scans, NMR imaging, or other imaging data) lab-test results, doctor's notes, insurance information, patient observations, purchase records, diet-related data, etc. However, in at least one embodiment, the HRDB 120 may receive and store EHRs 122 regardless of format.

In addition, or in the alternative, the HRDB 120 may access EHRs from a remotely located health records repository 145. Thus, the actual EHR records for an individual patient 140 need not be physically stored at the HRDB 120, so long as the records for a particular patient 140 can be retrieved from the repository 145 in response to requests received by the HRDB 120. Thus, a federated environment is contemplated in which the HRDB 120 is capable of retrieving related records from a plurality of distributed repositories in response to a given request.

A plurality of entities 102₁₋₂ are in communication with the HRDB 120 over a data communications network 110. In particular, a plurality of heath data providers 102₁ is shown. Each data provider 102₁ represents a physical location where an individual (i.e., the patients 140) may seek, obtain or receive healthcare related goods or services for which electronic health records may be generated and deposited with the HRDB 120. Illustratively, the data providers 102₁ represented in FIG. 1 include a dentist 105₁, a hospital 105₂, and a clinic 105₃. In addition to these more conventional healthcare service providers, FIG. 1 also shows a health food store 105₄. Accordingly, is contemplated that it data provider may be any entity capable of providing health-related data for individuals. Other such data providers include entities administering or providing nutritional supplements, weight-loss programs, alternative treatments such as chiropractic or acupuncture, etc. Further, the patients themselves may be data providers. Accordingly, data representing self-observations or other information provided by an individual patient (e.g., data indicating the use of a particular over-the counter-medication on a regular basis, or data reflecting the patient's on-going diet) may be received and stored.

The health data being received from the various data providers 102₁ may be in any of a variety of formats. Accordingly, it is contemplated that the HRDB 120 first normalizes the data into desired format. Further, the incoming data may be in an encrypted format for security purposes. Accordingly, appropriate decryption steps may be performed by the HRDB 120 upon receipt of data.

The data stored and managed in the HRDB 120 may be selectively requested by one or more health data consumers 102₂. In general, the health data consumers 102₂ include any entity desiring to access the electronic health records stored by the HRDB 120. Examples of health data consumers include research organizations and organizations performing clinical trials. In one embodiment, the health data consumers 102₂ may be required to register the activities for which they are seeking data in a registration database 135. Although mandatory registration is contemplated, in an alternative embodiment registration is optional or simply unavailable. A given registration record in the database 135 may include, for example, the registrant's name, contact information for the registrant, a description of the nature of the activity for which data is being sought, the description of how the data is to be used in the context of the activity, an estimated duration of the activity, etc.

It is noted that the health data consumers 102₂ may themselves be data providers. For example, a clinic conducting a clinical trial may access information stored at the HRDB 120 and following the trial may provide the results to the HRDB 120. In one embodiment, the organization operating the HRDB 120 may also be the data provider that provides some or all of the data for the EHR records. In another embodiment, the organization operating the HRDB may be independent from the entities providing the health-related services/data. In the latter case, it is contemplated that multiple HRDBs may exist and compete so that individual patients are free to choose a HRDB satisfying their own personal quality-of-service versus cost criteria (assuming a cost to the patients to have their data stored and managed).

In one embodiment, the HRDB 120 is configured with the necessary computing resources to process transaction requests from any of the relevant entities 102. Illustratively, the HRDB 120 is shown including a broker 125 configured to access the local health records repository 130, the remote health records repository 145 and the registration database 135. Although shown as a singular component, the broker 125 may be representative of a plurality of functions. In operation, incoming data may be received by the broker 125, which then performs or calls one or more appropriate data handling/processing functions in order to store the data as one or more EHRs 122 in the health record repository 130. Likewise, requests for data may be processed by the broker 125 to identify records satisfying the request in any of the EHR databases 130, 145.

According to various embodiments, one or more forms of restrictions may be placed on the health data consumers' 102₂ ability to access the electronic health records 122 from the HRDB 120. Additionally, or alternatively, the patients may specify selection criteria applicable by the broker 125 to identify prospective participants for clinical trials. To this end, the HRDB 120 may maintain policies 170 defined by the patients with respect to their respective EHRs. Illustratively, the policies 170 are stored in a policy database 160 accessible by the broker 125. The policies 170 may include a variety of information and the policy information for given user may be consolidated into a single policy or distributed over multiple policies. For example, multiple policies may be used where a first policy type contains data usage policy information and a second policy type contains selection policy information. Each of these kinds of policy information (whether or not contained in a single policy) are described below.

In one embodiment, data usage policy information specifies how and by whom patient data (in the EHRs) may be accessed and/or used. Restrictions of this nature include the degree to which anonymity must be maintained, identification of specific organizations (e.g., specific hospitals, medical organizations, etc.) who may use the data, specific uses of the data (e.g., cancer research, Alzheimer's research, etc.), restrictions on the requester's ability to allow third-party access to the data, etc.

Selection policy information defines criteria of the patient for participation in a clinical trial. Accordingly, selection policy information may be used by the broker 125 to identify patients who may be interested in participating in a given clinical trial. Selection policy information may include, for example, what type of clinical trials the patient would consider participating in (invasive, noninvasive, associated with medical conditions of interest to the patient), the method by which a selected patient agrees who agrees to participate in the trial wishes is to be contacted, the degree to which existing health-related data for the patient would be made available to the data consumer (the host organization conducting trial), etc. The selection policy information may also specify what actions would be taken if the patient is selected for the trial. For example, the policy information may specify that the patient agrees to provide contact information to the consumer upon being notified selection for participation in a trial. Alternatively, the policy information may specify that the details of the trial first be provided to the patient who then elects whether or not to provide (or have the HRDB 120 provide) their contact information to the consumer. The selection policy information may also specify whether the patient imposes any restrictions on the use of future data which may be derived from the clinical trial, although this may be determined by joining the appropriate data usage policy information when processing a request for data.

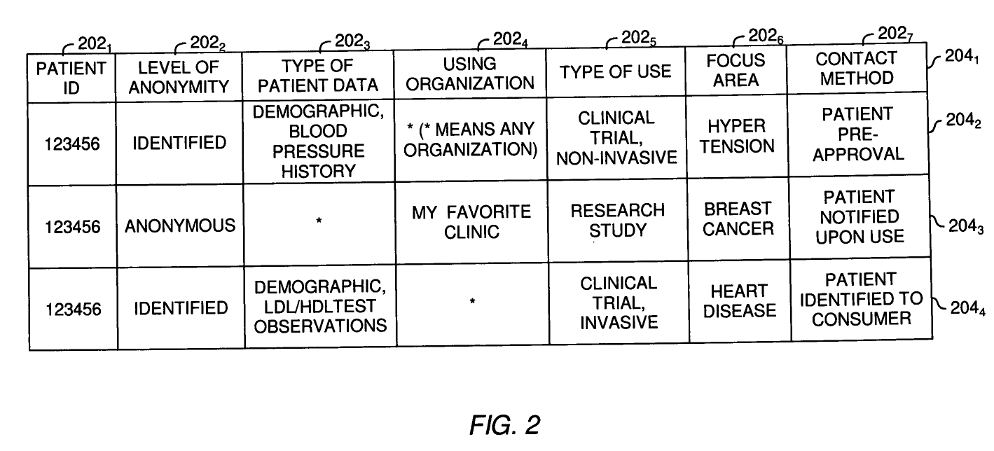

Referring now to FIG. 2, a table 200 is shown illustrating an embodiment of one of the policies 122. The table is defined as a plurality of columns 202₁₋₇ and rows 204₁₋₄. Each record (rows 204₂₋₄) in the table 200 defines a separate use restriction the patient's data or the patient's availability for a clinical trial. Each of the columns corresponds to a type of information identified in a header row 204₁. Illustratively, the table 200 includes a “patient ID” column 202₁, a “level of anonymity” column 202₂, a “type of patient data” column 202₃, a “using organization” column 202₄, a “type of use” column 2025, a “focus area” column 202₆, and a “contact method” column 202₇. The “patient ID” column 202, may contain any appropriate identifier to uniquely identify a given patient. In this case, the table 200 is a policy for a patient having the ID, 123456. The “level of anonymity” column 202₂ specifies the degree to which the patient desires to remain anonymous. Illustrative values for the column 202₂ include “identified” and “anonymous”. The “type of patient data” column 202₃ specifies the type of data on which the given restriction is defined. For example, the first restriction (row 204₂) is defined for blood pressure history, which is categorized in the demographic category. Thus, row 204₂ defines a restriction on access to the patient's blood pressure history data. The “using organization” column 202₄ identifies which organizations may request/access the patient data specified in column 202₃. For example, the first restriction (row 204₂) specifies that this restriction is not limited to any particular organization (indicated by the “*”). Compare the first restriction with the second restriction (row 204₃) which limits access to the identified data (in this case all data) to “MyFavoriteClinic”. The “type of use” column 202₅, specifies the context in which the patient data is requested/used. Illustratively, table 2 shows that the patient has restricted their data for use in clinical trials (rows 204_{2,4}) and research study (row 204₃). In the case of clinical trials, the patient has further specified whether the clinical trial may be invasive (row 204₄) or must be noninvasive (row 204₂). The “focus area” column 202₆, reflects whether the patient has specified a focus area restriction on the application of the patient data. For example, the first restriction (row 204₂) specifies that the patient is restricting his/her willingness to participate in a noninvasive clinical trial directed to hypertension. The “contact method” column 202₇ specifies how the patient wishes to be contacted regarding the data being accessed. Accordingly, the complete record defined by row 204₂ specifies a restriction on access to a patient's blood pressure history for consideration in a clinical trial and specifies that the patient's interest is limited to noninvasive clinical trial directed to hypertension.

It is understood that the policy shown in FIG. 2 is merely illustrative. Other policies may include other information. Further, it is contemplated that standardized forms may be used both to populate the policies and the compose requests submitted to the broker 125 requesting data. In this way the field names and data formats may be standardized, which may facilitate accurate identification of data and patients that satisfy a given request. Further, since the HRDB 120 may require specified information to be provided by the requester (e.g., the name of the requester, a project ID, the nature of the request (anonymized data or clinical trial request), etc.) a form-driven query interface help ensure the appropriate information is provided with the request.

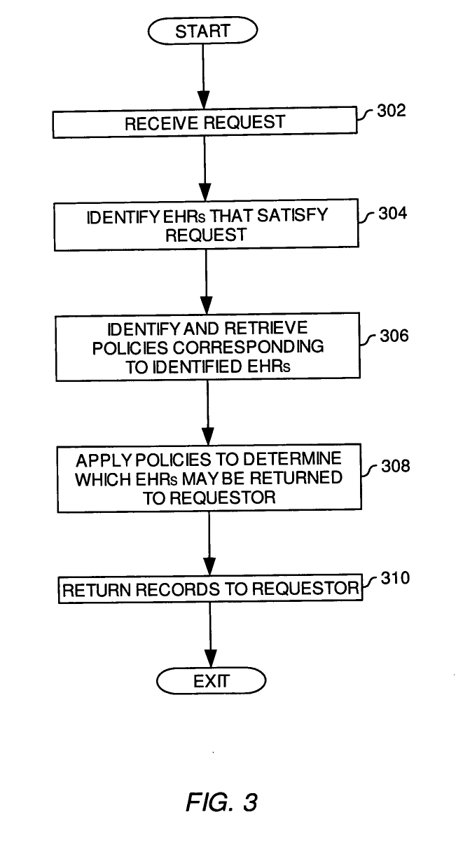

Referring now to FIG. 3, a flow chart is shown illustrating one method 300 of operation of the broker 125 to restrict access to EHRs on the basis of the policies. The method begins at step 302 where a request is received by the broker 125 from a data consumer 102₂. At step 304, the broker 125 identifies those EHRs that satisfy the request. The broker 125 then identifies and retrieves, at step 306, the user policies corresponding to the identified EHRs. For example, if the identified EHRs include records for patients having IDs 123456 and 445553, then the policies for these two patients are retrieved. At step 308, the retrieved policies are applied to the identified EHRs in order to determine whether any restrictions apply to the access of the EHRs. At step 310, the identified EHRs are returned the requesting data consumer 102₂, pursuant to any applicable restrictions determined at step 308. The method 300 then terminates.

In a particular instance the requesting data consumer 102₂ may be seeking specific data (e.g., data identifying certain patients as being susceptible to a particular disease). In this instance the requesting data consumer 102₂ may merely be seeking the number of patients who satisfy the specified criteria in the query submitted by the requesting data consumer 202₂. Alternatively, the requesting data consumer 102₂ may request the genders of the patients who satisfy the specified criteria in the query submitted by the requesting data consumer 202₂. In yet another case the requesting data consumer 102₂ may request the names of the patients who satisfy the specified criteria in the query submitted by the requesting data consumer 202₂. In a different instance the data consumer 202₂. In each case, which information is provide to the data consumer 102₂ will depend on the applicable usage policies 170. Further, the nature of the request may produce different results even where all other query conditions are the same. For example, in the case of a data consumer 102₂ seeking the names of patients who are susceptible to a particular disease, the names returned may depend on whether the request is being made for research purposes or for recruiting participants for clinical trial. Further, a given applicable policy may prevent the data consumer 102₂ from accessing the name of the respective patient. In this case, the relevant data (satisfying the query) of the respective patient may be “anonymized” (i.e., made anonymous by removing the patient's name and other identifying information, other than an ID code) before being returned to the data consumer 202₂. The data consumer 102₂ may then study the data and determine whether the respective anonymous patient is of interest. If so, the data consumer 102₂ may place a request with the broker 125 to have the patient contact the data consumer 102₂ if the patient has an interest in providing additional information and/or participating in a clinical trial. In one embodiment, the broker 125 then sends a notification to the respective patient(s) inviting the patient(s) to contact the broker 125, or perhaps request more information from the data consumer 102₂ before forfeiting its identify. In this way, the anonymity of the patient is preserved and only forfeited at the patient's discretion. In one embodiment, the broker 125 includes a notification generator 153 configured to generate and send the appropriate notifications to the respective patients via, e.g., the network 110. Again, the foregoing examples are more illustrative and precisely what information is made available to a data consumer 102₂ in response to a request will depend on the applicable polices.

It is understood that the functions of the broker 125 (or the HRDB 120, generally) need not be limited to those functions described above (i.e., pertaining to restricting assess to EHRs on the basis of the usage policies 170). For example, in one embodiment, the HRDB 120 may provide patient 140 healthcare records access reports 165 (e.g., monthly) detailing account activity. That is, the report 165 may reflect which of the patient's data was accessed, by whom and for what purpose. The reports 165 may be provided to the patients via email and/or by providing the patients with access to reports on-line (e.g., using a web-browser communicating with the HRDB over network 110). In one embodiment, the reports 165 are generated by a report generator 153 that accesses activity logs 155 maintained by the HRDB 120. In FIG. 1, the report generator 153 is illustratively shown as a function of the broker 125.

In another embodiment, the HRDB 120 is configured to determine a fee for a given transaction. The fee may be determined or calculated by a fee generator 157 (illustratively a function of the broker 125 in FIG. 1) on the basis of one of more fee schedules 159. The fee schedules 159 may prescribe any number of models for calculating a fee. For example, fees may be calculated on the basis of the number of records returned for a given request for a data consumer 202₂. In an alternative embodiment, a flat fee may be charged to a data consumer 102₂ who is then given unlimited access to the health records repository(s) 130,145, restricted only by the usage polices 160.

Thus, embodiments of the invention provide a patient-centric method for managing electronic medical records. The HRDB securely stores a comprehensive collection of health records associated with particular individuals and allows the individual patients to impose access and/or use restrictions on their records. Further, the individuals are permitted to modify their respective policies from time to time, according to one embodiment.

While the foregoing is directed to embodiments of the present invention, other and further embodiments of the invention may be devised without departing from the basic scope thereof, and the scope thereof is determined by the claims that follow.

What is claimed is:

1. A computer-implemented method of brokering health-related data, comprising:
receiving, from a requesting entity, a network request for health-related data pertaining to individuals;
identifying health-related data satisfying the request;
applying one or more policies to the identified health-related data; wherein the policies define access restrictions to the identified health-related data of the respective individuals to whom the identified health-related data pertains; and wherein the applied polices are defined by the respective individuals to whom the identified health-related data pertains; and
returning to the requesting entity, via a network communication, a portion of the health-related data as permitted by the applied policies and which satisfies the network request.

2. The method of claim 1, further comprising, prior to returning the portion of the health-related data to the requesting entity, requesting permission from the respective individuals to whom the health-related data pertains.

3. The method of claim 1, further comprising, receiving a network request from a given one of the individuals to modify the respective policy of the given individual.

4. The method of claim 1, wherein at least one of the applied policies specifies a level of anonymity for the respective individual.

5. The method of claim 1, wherein at least one of the applied policies specifies that the identity of the respective individual may not be disclosed, while health related data of the respective individual may be disclosed.

6. The method of claim 1, further comprising charging a fee to the requesting entity for the portion of health-related data.

7. The method of claim 1, further comprising:
receiving, from a requesting entity, another network request configured to identify qualified participants for a clinical trial;
accessing the one or more policies; wherein the policies define selection criteria specifying under which conditions the respective individuals are willing to participate in clinical trials; and
on the basis of the selection criteria, identifying one or more individuals who satisfy the network request configured to identify qualified participants for the clinical trial.

8. The method of claim 1, wherein the network request specifies at least one of: the name of the respective requesting entities and a manner in which the requested health-related data is to be used.

9. The method of claim 1, wherein the network request specifies that the requested health-related data is to be used for a clinical trial and wherein whether the portion of the health-related data returned to the requesting entity includes health-related data for a given individual depends on whether the respective policy for the given individual indicates a willingness to participate in clinical trials.

10. The method of claim 1, wherein the network request specifies that the requested health-related data is to be used for a research project, and wherein whether the portion of the health-related data returned to the requesting entity includes health-related data for a given individual depends on whether the respective policy for the given individual allows accessibility to the health-related data of the given individual for use in research projects.

11. The method of claim 1, wherein the access restrictions defined by the policies are based on how the requested health-related data is to be used by the requesting entity.

12. A computer-implemented method of brokering health-related data, comprising:
receiving, from a requesting entity, a first network request for health-related data pertaining to individuals;
identifying health-related data satisfying the request;
applying one or more policies to the identified health-related data; wherein the policies define access restrictions to the identified health-related data of the respective individuals to whom the identified health-related data pertains; wherein the applied polices are defined by the respective individuals to whom the identified health-related data pertains; and wherein at least one of the applied policies specifies that the identity of the respective individual is to remain anonymous, while health-related data of the respective individual may be disclosed;
returning, via a network communication, a portion of the health-related data as permitted by the applied policies and which satisfies the first network request;
receiving, from the requesting entity, a second network request indicating an interest in contacting the anonymous individual; and
notifying the anonymous individual of the second network request while maintaining the anonymity of the anonymous individual relative to the requesting entity.

13. The method of claim 12, further comprising:
receiving a third network request configured to identify qualified participants for a clinical trial;
accessing the one or more policies; wherein the policies define selection criteria specifying under which conditions the respective individuals are willing to participate in clinical trials; and
on the basis of the selection criteria, identifying one or more individuals who satisfy the third network request configured to identify qualified participants for the clinical trial.

14. The method of claim 12, wherein the access restrictions defined by the policies are based on how the requested health-related data is to be used by the requesting entity.

15. The method of claim 12, further comprising charging a fee to the requesting entity for the portion of health-related data.

16. A system, comprising:
a database containing health-related data pertaining to individuals;
a plurality of polices defining access restrictions to the health-related data, wherein the polices are defined by the respective individuals to whom the identified health-related data pertains;
a broker configured to:
receive, from requesting entities, network requests for the health-related data;
identify health-related data satisfying the request and the access restrictions of the policies; and
return, via a network communication, a portion of the health-related data as permitted by the policies and which satisfies the respective network requests.

17. The system of claim 16, wherein the request specifies at least one of: the name of the respective requesting entities and a manner in which the requested health-related data is to be used.

18. The system of claim 16, wherein the policies define further selection criteria specifying under which conditions the respective individuals are willing to participate in clinical trials and wherein the broker is further configured to:
receive network requests configured to identify qualified participants for a clinical trial;
access the policies; and
on the basis of the selection criteria, identify one or more individuals who satisfy the network requests configured to identify qualified participants for the clinical trial.

19. The system of claim 16, further comprising a registration database for storing registration information from the requesting entities; the registration information comprising at least one of a name of the requesting entities and a manner in which the requested health-related data is to be used; and wherein the broker is further configured to identify the health-related data on the basis of the registration information.

20. The system of claim 16, wherein the broker is further configured to charge a fee to the requesting entity for the portion of health-related data returned to the requesting entity.
